(19) United States
(12) Patent Application Publication
(10) Pub. No.: US 2018/0356242 A1
(43) Pub. Date: Dec. 13, 2018

(54) VEHICLE RANGE PREDICTION WITH WIND AND SOLAR COMPENSATION

(71) Applicant: GM Global Technology Operations LLC, Detroit, MI (US)

(72) Inventors: Charles Jacob KRITZMACHER, Far Hills, NJ (US); Christopher J. TWAROG, Franklin, MI (US); Todd P. LINDEMANN, Howell, MI (US); Ramon A. ALONSO, Highland, MI (US)

(21) Appl. No.: 15/619,781

(22) Filed: Jun. 12, 2017

(51) Int. Cl. G01C 21/34; B60W 50/00; B60L 11/18; B60L 15/20; G01C 21/36

(52) U.S. Cl. CPC G01C 21/3469; B60W 50/0097; G01C 21/3691; B60L 15/2045; B60L 11/1861

(57) ABSTRACT

A control system of a vehicle comprising an electric motor that drives the vehicle, a battery that provides electrical power to the electric motor, a wireless transceiver that communicates with a weather data server, and a vehicle range prediction module coupled to the wireless transceiver. The vehicle range prediction module receives from the weather data server a plurality of wind characteristic data, each of the wind characteristic data associated with one of a plurality of points along a predetermined route to be traveled by the vehicle and a plurality of solar energy data, each of the solar energy data associated with one of the plurality of points along the predetermined route to be traveled by the vehicle. The vehicle range prediction module determines the predicted range of the vehicle based on the wind characteristic data and the solar energy data.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

Generally, the range of an all-electric vehicle or a hybrid electric vehicle may be increased or decreased by anything that increases or decreases the drain on the battery. In particular, the nominal range of an all-electric vehicle or a hybrid electric vehicle may be affected by wind speed and direction, as well as by temperature. During a trip, the expected range of the vehicle may be significantly increased by strong and steady tailwinds and may be significantly decreased by strong and steady headwinds. Similarly, during hot weather, the expected range of the vehicle may be significantly decreased by use of the heating, ventilation, and air conditioning (HVAC) system to cool the passenger compartment.

Range prediction accuracy is typically based on historical averages. When the outside conditions, such as wind and solar heating, cause deviations from these historical averages, range accuracy is affected and a vehicle may be stranded. This causes range anxiety among drivers. This is particularly critical in an all-electric vehicle, since charging stations are considerably less numerous than gas stations.

### SUMMARY

A control system of a vehicle comprises i) an electric motor to drive the vehicle, ii) a battery to provide electrical power to the electric motor, iii) a wireless transceiver that communicates with a weather data server, and iv) a vehicle range prediction module coupled to the wireless transceiver. The vehicle range prediction module receives from the weather data server at least one of i) a plurality of wind characteristic data and ii) a plurality of solar energy data. Each wind characteristic data is associated with one of a plurality of points along a predetermined route to be traveled by the vehicle. The vehicle range prediction module determines a predicted range of the vehicle based on the wind characteristic data. Each solar energy data is associated with one of the plurality of points along the predetermined route. The vehicle range prediction module determines the predicted range of the vehicle based on the solar energy data.

In other features, the wind characteristic data comprises wind velocity and wind direction at each of the plurality of points along the predetermined route. In other features, the wind velocity and wind direction at each of the plurality of points along the predetermined route is associated with a predicted time at which the vehicle will be passing each point. In other features, the vehicle range prediction module receives real-time wind characteristic data from the weather data server while the vehicle is traveling the predetermined route. In other features, the vehicle range prediction module updates the predicted range of the vehicle based on the received real-time wind characteristic data.

In other features, the solar energy data comprises ultraviolet index (UVI) data at each of the plurality of points along the predetermined route. In other features, the UVI data at each of the plurality of points along the predetermined route is associated with a predicted time at which the vehicle will be passing each point. In other features, the vehicle range prediction module receives real-time solar energy data from the weather data server while the vehicle is traveling the predetermined route. In other features, the vehicle range prediction module updates the predicted range of the vehicle based on the received real-time solar energy data. In other features, the vehicle range prediction module and the wireless transceiver are disposed in an infotainment module of the vehicle.

An apparatus for predicting the range of a vehicle having an electric motor and a battery to provide electrical power to the electric motor comprises a wireless transceiver that communicates with a weather data server and a vehicle range prediction module coupled to the wireless transceiver. The vehicle range prediction module receives from the weather data server at least one of i) a plurality of wind characteristic data and ii) a plurality of solar energy data. Each wind characteristic data is associated with one of a plurality of points along a predetermined route to be traveled by the vehicle. The vehicle range prediction module determines a predicted range of the vehicle based on the wind characteristic data. Each solar energy data is associated with one of the plurality of points along the predetermined route to be traveled by the vehicle. The vehicle range prediction module determines the predicted range of the vehicle based on the solar energy data.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an exemplary vehicle engine system and an exemplary drive system according to the principles of the present disclosure;

FIG. 2 is a functional block diagram of a communication system for accessing weather data for use in vehicle range prediction according to the principles of the present disclosure;

FIG. 3 is a flow diagram depicting a method of using wind characteristics to predict vehicle range according to the principles of the present disclosure; and

FIG. 4 is a flow diagram depicting a method of using solar energy characteristics to predict vehicle range according to the principles of the present disclosure.

In the drawings, reference numbers may be reused to identify similar and/or identical elements.

### DETAILED DESCRIPTION

The present disclosure relates to a vehicle control system that incorporates: 1) wind speed and direction and 2) UV Index as a proxy for solar energy into a predictive model to estimate energy consumed during a known trip and to calculate the adjusted vehicle range that results. The disclosed vehicle control system uses a cellular data connection to obtain real-time wind and solar energy data from the internet. The real-time wind and solar energy data enables the disclosed vehicle control system to determine predictable range behavior in varying wind and sunlight conditions. This “predictive” range estimation based on expected wind and UV index along a known trip route provides greater accuracy than “reactive” range estimation based on historical vehicle efficiency and historical HVAC performance.

The cellular data connection may be provided by a driver's cell phone or by a cellular transceiver that is built into the vehicle. The cell-phone weather data provides the most up-to-date predictions of wind conditions and UV conditions and vastly improves prediction accuracy over reactive predictions. The real-time data for the direction and magnitude of wind may incorporate: i) time of day, and ii) location(s) along the route. The real-time data for solar energy may be provided on a 0-11 scale that incorporates: 1) time of day, ii) location(s) along the route, iii) cloud cover, and/or iv) solar intensity.

Advantageously, the disclosed vehicle control system may provide additional consideration for error correction. The data associated with the drive energy actually used are accumulated and evaluated to create a multiplier applied at the end of the calculation to mitigate any error in the initial calculations as the drive progresses. This learning capability enables the wind calculations to become more accurate as data is accumulated and compared to the predictions. The wind direction and location are analyzed and used to mitigate wind effects based on driving environment. Lower speed limits and lower current active speeds of any road segment will have reduced impact. Urban canyons, mountainous regions, and other wind inhibiting or wind changing features may be considered as well. The directionality (or orientation) of the traveled route may also be incorporated into the energy impacts.

Similarly, the data associated with the HVAC energy actually used are accumulated and evaluated to create a multiplier to be applied at the end of the calculations to mitigate any error in the initial calculations as the drive progresses. This learning capability enables the solar energy calculations to become more accurate as data is accumulated and compared to the predictions. The UV Index and locations are analyzed. Environments with extreme tree cover, urban canyons, mountainous regions, and time of day may also be considered when determining the UV Index impact.

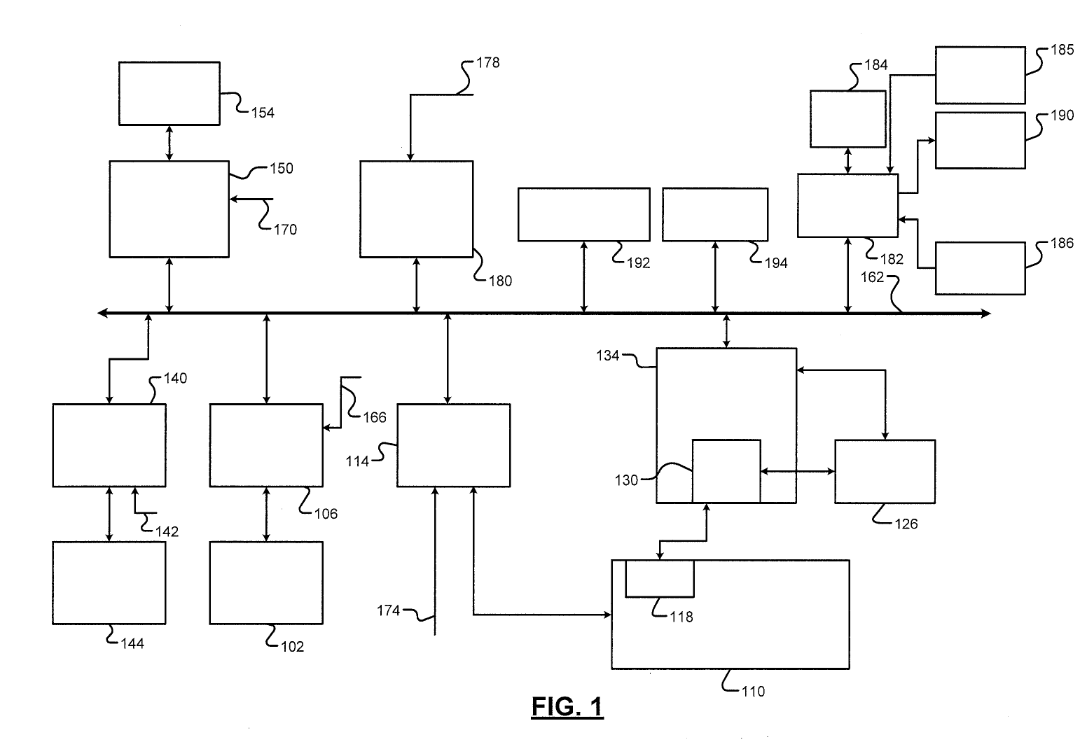

Referring now to FIG. 1, a functional block diagram of an example vehicle system is presented. While a vehicle system for a hybrid vehicle is shown and will be described, the present disclosure is also applicable to all-electric vehicles, fuel cell vehicles, autonomous vehicles, non-electric vehicles, and other types of vehicles. Also, while the example of a vehicle is provided, the present application is also applicable to non-vehicle implementations.

An engine 102 combusts an air/fuel mixture to generate drive torque. An engine control module (ECM) 106 controls the engine 102 based on one or more driver inputs. For example, the ECM 106 may control actuation of engine actuators, such as a throttle valve, one or more spark plugs, one or more fuel injectors, valve actuators, camshaft phasers, an exhaust gas recirculation (EGR) valve, one or more boost devices, and other suitable engine actuators.

The engine 102 may output torque to a transmission 110. A transmission control module (TCM) 114 controls operation of the transmission 110. For example, the TCM 114 may control gear selection within the transmission 110 and one or more torque transfer devices (e.g., a torque converter, one or more clutches, etc.).

The vehicle system may include one or more electric motors. For example, an electric motor 118 may be implemented within the transmission 110 as shown in the example of FIG. 1. An electric motor can act as either a generator or as a motor at a given time. When acting as a generator, an electric motor converts mechanical energy into electrical energy. The electrical energy can be, for example, used to charge a battery 126 via a power control device (PCD) 130. When acting as a motor, an electric motor generates torque that may be used, for example, to supplement or replace torque output by the engine 102. While the example of one electric motor is provided, the vehicle may include zero or more than one electric motor.

A power inverter control module (PIM) 134 may control the electric motor 118 and the PCD 130. The PCD 130 applies (e.g., direct current) power from the battery 126 to the (e.g., alternating current) electric motor 118 based on signals from the PIM 134, and the PCD 130 provides power output by the electric motor 118, for example, to the battery 126. The PIM 134 may be referred to as a power inverter module (PIM) in various implementations.

A steering control module 140 controls steering/turning of wheels of the vehicle, for example, based on driver turning of a steering wheel within the vehicle and/or steering commands from one or more vehicle control modules. A steering wheel angle sensor (SWA) monitors rotational position of the steering wheel and generates a SWA 142 based on the position of the steering wheel. As an example, the steering control module 140 may control vehicle steering via an EPS motor 144 based on the SWA 142. However, the vehicle may include another type of steering system. An electronic brake control module (EBCM) 150 may selectively control brakes 154 of the vehicle.

Modules of the vehicle may share parameters via a controller area network (CAN) 162. The CAN 162 may also be referred to as a car area network. For example, the CAN 162 may include one or more data buses. Various parameters may be made available by a given control module to other control modules via the CAN 162.

The driver inputs may include, for example, an accelerator pedal position (APP) 166 which may be provided to the ECM 106. A brake pedal position (BPP) 170 may be provided to the EBCM 150. A position 174 of a park, reverse, neutral, drive lever (PRNDL) may be provided to the TCM 114. An ignition state 178 may be provided to a body control module (BCM) 180. For example, the ignition state 178 may be input by a driver via an ignition key, button, or switch. At a given time, the ignition state 178 may be one of off, accessory, run, or crank.

The vehicle system also includes an infotainment module 182. The infotainment module 182 controls what is displayed on a display 184. The display 184 may be a touchscreen display in various implementations and transmit signals indicative of user input to the display 184 to infotainment module 182. Infotainment module 182 may additionally or alternatively receive signals indicative of user input from one or more other user input devices 185, such as one or more switches, buttons, knobs, etc.

Infotainment module 182 may receive input from a plurality of external sensors and cameras, generally illustrated in FIG. 1 by 186. For example, the infotainment module 182 may display video, various views, and/or alerts on the display 184 via input from the external sensors and cameras 186. At least some of the external sensor and camera information may be transmitted to infotainment module 182 via controller area network (CAN) 162.

Infotainment module 182 may also generate output via one or more other devices. For example, the infotainment module 182 may output sound via one or more speakers 190 of the vehicle. The vehicle may include one or more additional control modules that are not shown, such as a chassis control module, a battery pack control module, etc. The vehicle may omit one or more of the control modules shown and discussed.

According to an embodiment of the present disclosure, the vehicle also comprises vehicle range prediction module 192 and mobile transceiver 194. In FIG. 1, vehicle range prediction module 192 and mobile transceiver 194 are shown as stand-alone modules that are communicatively coupled to infotainment module 182 via controller area network 162. However, those skilled in the art will readily understand that in alternate embodiments, one or both of vehicle range prediction module 192 and mobile transceiver 194 may be incorporated as a submodule within infotainment module 182.

As explained below in greater detail, vehicle range prediction module 192 is configured to communicate with a cellular network via mobile transceiver 194. Furthermore, mobile transceiver 194 may comprise a plurality of wireless transceivers configured to communicate with a plurality of diverse external networks and devices, including cellular networks (e.g., 3G networks, 4G networks, LTE networks, etc.), Bluetooth-enabled devices, WiFi networks, and the like. Therefore, vehicle range prediction module 192 is also configured to communicate with a nearby mobile device, such as a smartphone, via mobile transceiver 194 using a Bluetooth connection or a WiFi connection.

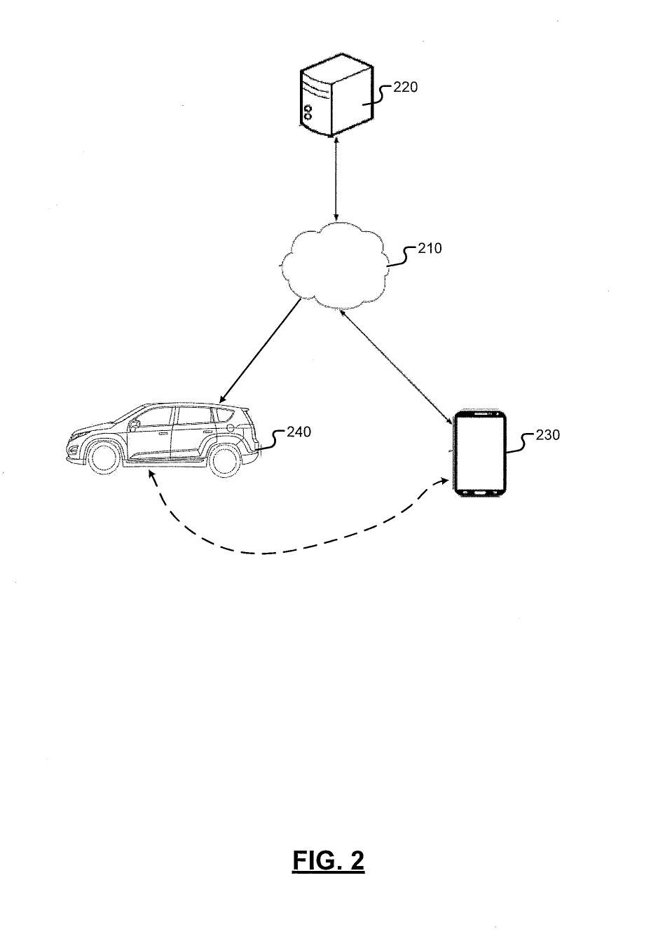

FIG. 2 is a functional block diagram of a communication system for accessing weather data for use in vehicle range prediction according to the principles of the present disclosure. Cloud server 220 may be accessed by and communicate with mobile transceiver 194 in vehicle 240 and/or mobile device 230 associated with a user or passenger in vehicle 240. Server 220 communicates wirelessly with mobile transceiver 194 in vehicle 240 and/or mobile device 230 via an Internet protocol (IP) network 210, such as the Internet. In an exemplary embodiment, mobile device 230 may be a smartphone 230. Like mobile transceiver 194, mobile device 230 may comprise a plurality of wireless transceivers configured to communicate with a plurality of diverse networks and devices, including cellular networks (e.g., 3G networks, 4G networks, LTE networks, etc.), Bluetooth-enabled devices, WiFi networks, and the like.

In an exemplary embodiment, the driver of vehicle 240 may use a mapping application executed in infotainment module 182 and/or vehicle range prediction module 192 to program a trip from an origination point to a destination point along a predetermined route. According to the principles of the present disclosure, vehicle range prediction module 192 uses mobile transceiver 194 to communicate with cloud server 220 to retrieve predicted weather data, including wind characteristics (i.e., speed and direction) and ultraviolet index (UVI) data (as a proxy for solar energy) at a plurality of points or road segments along the predetermined route. Since wind characteristics and UV index at a point can change substantially in a matter of minutes, the predicted weather data preferably includes wind characteristics and UVI data associated with each of the plurality of points (or road segments) along the predetermined route at the approximate time that vehicle 240 passes or traverses each point or road segment.

By way of example, suppose a driver selects a predetermined route from origination point A to destination point B that covers 240 miles and the trip will occur from 1 PM to 5 PM (i.e., 4 hour duration) at a targeted speed of 60 mph. Since the vehicle 240 will travel approximately one mile every minute, the vehicle range prediction module 192 may divide the predetermined route into 240 evenly spaced points or road segments and obtain minute-by-minute weather/solar data at each of the 240 points/segments. Thus, the vehicle range prediction module 192 may obtain wind/solar data for the origination point A at 1 PM, wind/solar data for the first mile point at 1:01 PM, wind/solar data for the second mile point at 1:02 PM, wind/solar data for the third mile point at 1:03 PM and so forth. Similarly, the vehicle range prediction module 192 may obtain wind/solar data for the mid-point of the predetermined route (i.e., 120^{th} mile point) at 3 PM. In an advantageous embodiment, vehicle range prediction module 192 may continue to obtain updated wind/solar data during the trip as the wind and solar data may change substantially in a matter of hours (or perhaps minutes) from earlier predictions.

As described below in greater detail, vehicle range prediction module 192 may be programmed with the particular aerodynamic characteristics of vehicle 240 and the particular energy characteristics of the heating, ventilation and air conditioning (HVAC) system in vehicle 240 to enable vehicle range prediction module 192 to adjust the nominal vehicle range estimates (based on historic data) for vehicle 240 and battery 126 to obtain a more accurate predicted vehicle range that accounts for the particular weather characteristics and solar characteristics that vehicle 240 encounters at each point along the predetermined route from 1 PM to 5 PM.

In another exemplary embodiment, the driver of vehicle 240 may use a mapping application executed by mobile device 230 to program the same trip from origination point A to destination point B along the predetermined route. In such an embodiment, mobile device 230 accesses cloud server 220 directly to obtain the required wind characteristics (i.e., speed and direction) and ultraviolet index (UVI) data (as a proxy for solar energy) at the plurality of points or road segments along the predetermined route. Similarly, the mobile device 230 must be programmed with the same information regarding the particular aerodynamic characteristics of vehicle 240 and the particular energy characteristics of the HVAC system in vehicle 240 in order to obtain a more accurate predicted vehicle range that accounts for the particular weather characteristics and solar characteristics that vehicle 240 encounters at each point along the predetermined route from 1 PM to 5 PM. The mobile device 230 may communicate wirelessly (e.g., via Bluetooth or WiFi) with mobile transceiver 194 in vehicle 240 (as indicated by the dotted line in FIG. 2) in order to transfer data between mobile device 230 and vehicle 240. Thus, the predicted vehicle range determined by mobile device 230 may be transmitted to vehicle 240 for display by infotainment module 182.

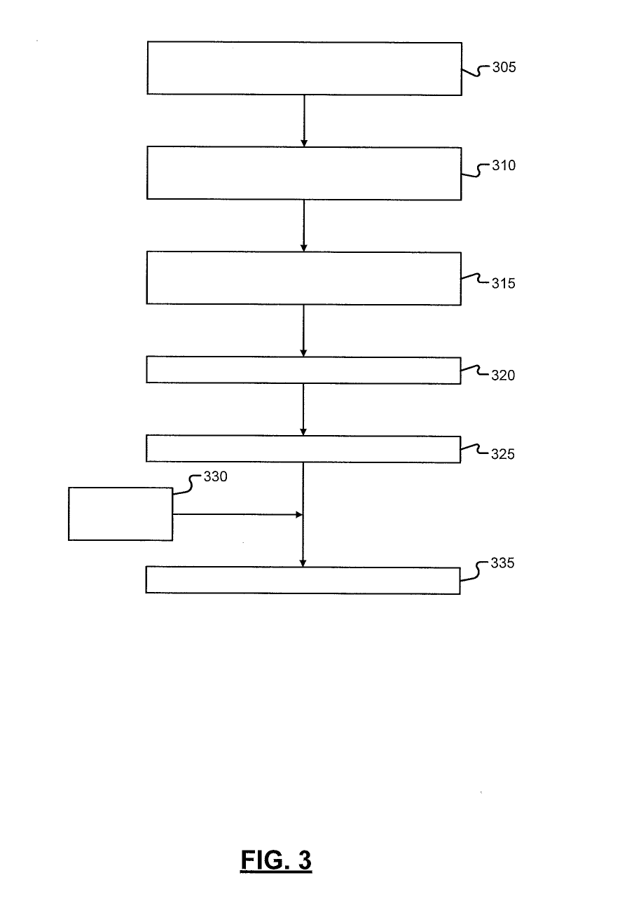

FIG. 3 is a flow diagram depicting a method of using wind characteristics to predict vehicle range according to the principles of the present disclosure. The method may be performed by vehicle range prediction module 192 or by mobile device 230. However, for the sake of simplicity in describing the embodiment, it will be assumed that vehicle range prediction module 192 is performing the method in FIG. 3.

In 305, vehicle range prediction module 192 accesses weather data in cloud server 220 via a cellular data connection. The vehicle range prediction module 192 therefore finds the wind characteristics at selected points along the predetermined route at the particular points in time when vehicle 240 is passing those points.

In 310, the vehicle range prediction module 192 adjusts the vehicle velocity (and power consumption) based on wind speed and direction to maintain a target speed (e.g., 60 mph). For example, a tailwind will reduce power consumption so that less energy is needed to maintain a target speed. This will increase battery or fuel range. In 315, the vehicle range prediction module 192 adjusts (or determines) the correct vehicle aerodynamic coefficients to compensate for the wind characteristics. These coefficients will be unique to each vehicle model.

In 320, the vehicle range prediction module 192 may calculate a nominal road load equation. In 325, the vehicle range prediction module 192 generates an adjusted road load equation based on the vehicle aerodynamic coefficients. An example of an adjusted road load equation may be:

P_{D}=(d₀+d₁×v₁+d₂×v₂²)×v₁,

where v₁ represents vehicle velocity and v₂ represents velocity adjusted for wind. The coefficients d₀, d₁, and d₂ represent the unique aerodynamic coefficients associated with each vehicle model.

In 330, the vehicle range prediction module 192 may further adjust the predicted vehicle range using additional power equations (e.g., solar energy effects on HVAC). Finally, in 335, the vehicle range prediction module 192 determines the new predicted range. This value may be displayed on infotainment module 182 on display 184. By way of example, infotainment module 182 may depict the predetermined route from point A to point B on a map on display 184. The portion of the predetermined route within the predicted fuel range may be shown as a green line along the predetermined route. The portion of the predetermined route beyond the predicted fuel range may be shown as a red line along the predetermined route.

Where wind is concerned, the vehicle range prediction module 192 determines the impact of air on the vehicle 240 (i.e., by increasing the air component of the standard or nominal road load calculation), which shows the increased drag due to wind on the behavior of the vehicle 240. Using the heading and wind speed, the vehicle range prediction module 192 determines the likely impact of that additional air movement on the vehicle. For example, side-loaded wind forces account for additional energy needed to maintain a speed as there is increased load on the vehicle to maintain a heading differently than a head-on wind would cause.

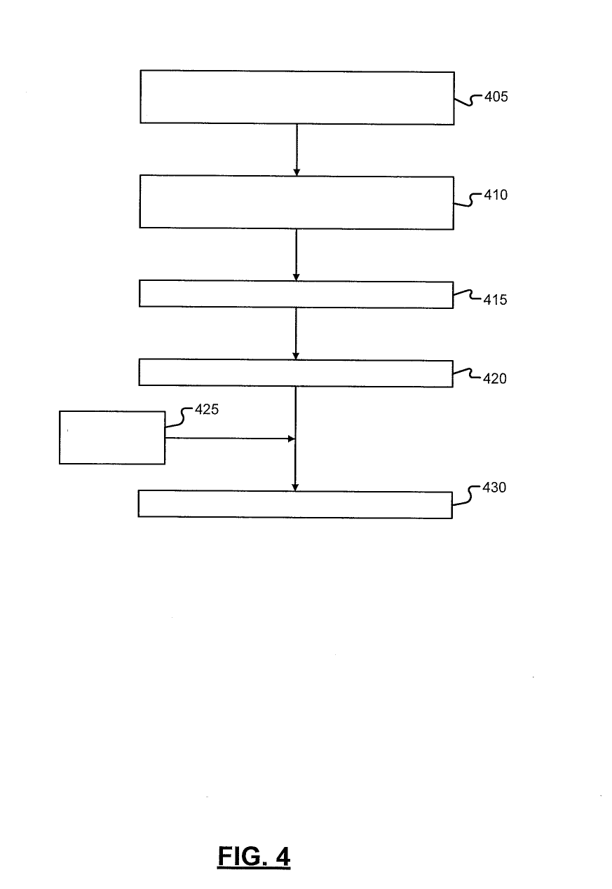

FIG. 4 is a flow diagram depicting a method of using solar energy characteristics to predict vehicle range according to the principles of the present disclosure. As in FIG. 3, the method may be performed by vehicle range prediction module 192 or by mobile device 230. However, for the sake of simplicity in describing the embodiment, it will be assumed that vehicle range prediction module 192 is performing the method in FIG. 4.

In 405, the vehicle range prediction module 192 accesses weather data in cloud server 220 via a cellular data connection. The vehicle range prediction module 192 therefore finds the UVI data at selected points along the predetermined route at the particular points in time when vehicle 240 is passing those points.

In 410, the vehicle range prediction module 192 adjusts the HVAC coefficients based on UVI data at selected points along the predetermined route. The HVAC coefficients will be unique to each vehicle model.

In 415, the vehicle range prediction module 192 calculates a nominal HVAC load equation. In 420, vehicle range prediction module 192 generates an adjusted HVAC load equation based on the unique vehicle HVAC coefficients. An example of an adjusted HVAC load equation may be:

P_{HVAC}=(h₀+h₁×v₁+h₂×v₁²)×[h₃(UVI)+h₄(UVI)×(ΔT+UVI)],

where h₃(UVI) and h₄(UVI) represent coefficients dependent on UVI data and where v₁ and AT represent velocity and temperature difference, respectively.

The HVAC load calculation represents a way of quantifying the impact of the solar load on the energy required to maintain the passenger compartment set point temperature.

The vehicle range prediction module 192 adds a modifier to a nominal range prediction model based on a delta temperature value (ΔT), where the delta temperature value is the difference between the inside set point temperature (e.g., 72 degrees) in the passenger compartment and the outside air temperature (e.g., 81 degrees). The vehicle range prediction module 192 uses the UV Index value to increase the solar-compensated predicted value from the nominal (reactive) prediction by multiplying by a number greater than 1 as the UV index increases. This implementation allows for a simpler implementation and calibration strategy.

In 425, the vehicle range prediction module 192 may further adjust the predicted battery or fuel range using additional power equations (e.g., wind energy effects. Finally, in 430, the vehicle range prediction module 192 determines the new predicted range.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements.

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

The following description is merely exemplary in nature and is in no way intended to limit the disclosure, its application, or uses. For purposes of clarity, the same reference numbers will be used in the drawings to identify similar elements. As used herein, the phrase “at least one of A, B, and C” should be construed to mean a logical (A OR B OR C), using a non-exclusive logical OR, and should not be construed to mean “at least one of A, at least one of B, and at least one of C.” It should be understood that steps within a method may be executed in different order without altering the principles of the present disclosure.

As used herein, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term “code”, as used above, may include software, firmware, and/or microcode, and may refer to programs, routines, functions, classes, data structures, and/or objects. The term “shared processor circuit” encompasses a single processor circuit that executes some or all code from multiple modules. The term “group processor circuit” encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term “shared memory circuit” encompasses a single memory circuit that stores some or all code from multiple modules. The term “group memory circuit” encompasses a memory circuit that, in combination with additional memories, stores some or all code from one or more modules.

The term “memory circuit” is a subset of the term “computer-readable medium”. The term “computer-readable medium”, as used herein, does not encompass transitory electrical or electromagnetic signals propagating through a medium (such as on a carrier wave); the term “computer-readable medium” may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

1. A control system of a vehicle comprising:
an electric motor configured to drive the vehicle;
a battery configured to provide electrical power to the electric motor;
a wireless transceiver configured to communicate with a weather data server; and
a vehicle range prediction module coupled to the wireless transceiver and configured to receive from the weather data server:
a plurality of wind characteristic data, each of the wind characteristic data associated with one of a plurality of points along a predetermined route to be traveled by the vehicle; and
a plurality of solar energy data, each of the solar energy data associated with one of the plurality of points along the predetermined route to be traveled by the vehicle,
wherein the vehicle range prediction module is further configured to determine a predicted range of the vehicle based on the wind characteristic data and the solar energy data.

2. The control system of claim 1, wherein the wind characteristic data comprises wind velocity and wind direction at each of the plurality of points along the predetermined route.

3. The control system of claim 2, wherein the wind velocity and wind direction at each of the plurality of points along the predetermined route is associated with a predicted time at which the vehicle will be passing each point.

4. The control system of claim 1, wherein the vehicle range prediction module is further configured to receive real-time wind characteristic data from the weather data server while the vehicle is traveling the predetermined route.

5. The control system of claim 4, wherein the vehicle range prediction module is further configured to update the predicted range of the vehicle based on the received real-time wind characteristic data.

6. The control system of claim 1, wherein the solar energy data comprises ultraviolet index (UVI) data at each of the plurality of points along the predetermined route.

7. The control system of claim 6, wherein the UVI data at each of the plurality of points along the predetermined route is associated with a predicted time at which the vehicle will be passing each point.

8. The control system of claim 1, wherein the vehicle range prediction module is further configured to receive real-time solar energy data from the weather data server while the vehicle is traveling the predetermined route.

9. The control system of claim 8, wherein the vehicle range prediction module is further configured to update the predicted range of the vehicle based on the received real-time solar energy data.

10. The control system of claim 1, wherein the vehicle range prediction module and the wireless transceiver are disposed in an infotainment module of the vehicle.

11. An apparatus for predicting the range of a vehicle having an electric motor and a battery configured to provide electrical power to the electric motor, the apparatus comprising:
a wireless transceiver configured to communicate with a weather data server; and
a vehicle range prediction module coupled to the wireless transceiver and configured to receive from the weather data server at least one of:
a plurality of wind characteristic data, each of the wind characteristic data associated with one of a plurality of points along a predetermined route to be traveled by the vehicle; and
a plurality of solar energy data, each of the solar energy data associated with one of the plurality of points along the predetermined route to be traveled by the vehicle;
wherein the vehicle range prediction module is further configured to determine a predicted range of the vehicle based on the wind characteristic data and the solar energy data.

12. The apparatus of claim 11, wherein the wind characteristic data comprises wind velocity and wind direction at each of the plurality of points along the predetermined route.

13. The apparatus of claim 12, wherein the wind velocity and wind direction at each of the plurality of points along the predetermined route is associated with a predicted time at which the vehicle will be passing each point.

14. The apparatus of claim 11, wherein the vehicle range prediction module is further configured to receive real-time wind characteristic data from the weather data server while the vehicle is traveling the predetermined route.

15. The apparatus of claim 14, wherein the vehicle range prediction module is further configured to update the predicted range of the vehicle based on the received real-time wind characteristic data.

16. The apparatus of claim 12, wherein the solar energy data comprises ultraviolet index (UVI) data at each of the plurality of points along the predetermined route.

17. The apparatus of claim 16, wherein the UVI data at each of the plurality of points along the predetermined route is associated with a predicted time at which the vehicle will be passing each point.

18. The apparatus of claim 11, wherein the vehicle range prediction module is further configured to receive real-time solar energy data from the weather data server while the vehicle is traveling the predetermined route.

19. The apparatus of claim 20, wherein the vehicle range prediction module is further configured to update the predicted range of the vehicle based on the received real-time solar energy data.

20. The apparatus of claim 11, wherein the vehicle range prediction module and the wireless transceiver are disposed in wireless mobile device configured to communicate with a wireless transceiver in the vehicle.
